(19) United States
(12) Patent Application Publication
(10) Pub. No.: US 2004/0086038 A1
(43) Pub. Date: May 6, 2004

(54) System and method for using microlets in communications

(76) Inventor: Daniel Kilbank, Potomac, MD (US)

Correspondence Address: HOGAN & HARTSON LLP, IP GROUP, COLUMBIA SQUARE, 555 THIRTEENTH STREET, N.W., WASHINGTON, DC, 20004, US

(21) Appl. No.: 10/419,986

(22) Filed: Apr. 22, 2003

Related U.S. Application Data
(60) Provisional application No. 60/374,504, filed on Apr. 23, 2002.

(51) Int. Cl. H04B 1/66

(52) U.S. Cl. 375/240

(57) ABSTRACT

A system and method for using microlets in communication is disclosed. A microlet corresponds to a transform of information based upon its quantum element state. Microlet communications employs modems, encoders, sequencers and other devices to compress data according to its quantum information. Using a virtual quantum register, changes in the microlet transforms and their quantum states are used to exchange information.

### CROSS REFERENCE TO RELATED APPLICATIONS

This application claims benefit from U.S. Provisional Patent Application Serial No. 60/374,504, entitled “Means for Using Microlets in Communications,” filed Apr. 23, 2002, which is hereby incorporated by reference.

### BACKGROUND OF THE INVENTION

1. Field of the Invention

The present invention discloses the transmission of information, and, more particularly, the invention relates to a method, system or device to enhance speed and throughput of any form of information over any form of communications or communications medium.

2. Discussion of the Related Art

The transmission of data from one point to another is of increasing importance. From dial-up to broadband, users seek to receive more information in a quicker manner. Many of the constraints on speed and bandwidth lie in the inefficiencies of the systems and methods used in transmitting the data. Physical and practical constraints, however, also exist.

Most importantly there may be two types of compression: lossless and lossy. There are any numbers of techniques that use lossy compression to enhance and speed-up information transfer or for better use of storage. Computers may speak in one of two languages, either analog or digital. Analog represents digital information by using sine and cosine waveforms to represent 0 and 1. Digital information is created using the base 2 number system, better known as the binary number system. The binary number system has two elements: a zero and a one. A bit consists of a zero and one, and eight bits creates one byte. A byte can represent all of the values between 0 and 256. Most computers may use Unicode which consist of 16 bit bytes, 24, and 32 bit allocations, although some may use 8 bit/bytes. Basic text and everyday items are coded under Standard ASCII Character Set that is a basic form of compression.

The most common methods of compression are Huffman coding, Arithmetic, PPM, Markov, RLE (Run Length Encoding), and Multi-media compressions such as JPEG/MPEG.

A number of elements may be missing from these models. First, lossless compression is difficult, because it desires that elements of an original dataset be preserved during compression and transmission, and experience no loss upon un-compressing, hence the name lossless compression. The Huffman model was developed, and although it has been improved upon, there may be criterion that should be met in order for these compressions to work. Typically, there needs to be succession runs of similar information data elements or elements that have been mapped to a different code source. Lossy compression techniques truncate information by using association, quantization, or simply by only encoding information in a set boundary. In most cases this may be acceptable because the data is not imperative to the application or source and can therefore be cut out. It is a very lengthy and computationally expensive task to code in binary alone.

Further, consumer and user demands for larger data files are increasing. Communication systems should be able to send video, audio, text, and other data. Digital photos have become commonplace. Users routinely download videos, movies, and other files to view from remote locations. This process is convenient and easy, but also time consuming because of constraints on the data transmission capabilities of the communication system. In addition, constraints may occur when using plain old telephone systems (“POTS”) in accessing networks and transmitting data. Future applications should try to overcome these constraints without requiring cost-prohibitive upgrades or replacing current infrastructure or systems.

### SUMMARY OF THE INVENTION

Accordingly, the present invention is directed to a system and method for using microlets in communications. In conforming with trends toward flexible receivers and more robust and dependable, scalable communications solutions, embodiments of the present invention disclose a microlet based modem ASIC and software/firmware solution that enables more bits per cycle and operates in the optimal space between the peak stopband attenuations of wavelet technologies. This feature will allow for greater detail, lossless compression, reduced bandwidth for the same amount of information, and greatly increased speeds. Digital signal processing, frequency modulation, frequency phase, and phase amplitude vector modulation are the basics for wired and wireless communications and are part of the disclosed architectures, processes and modems.

Mapped to the current protocols, the disclosed embodiments may be applicable for all communication applications from POTS through optical/dark fiber, satellite, wireless, and the like. The disclosed embodiments may be frequency transparent. In the current client/server commuting operator relationship, the disclosed embodiments are transparent to the network infrastructure while producing sizable gains.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings. To achieve these and other advantages and in accordance with the purpose of the present invention, as embodied and broadly described, a system for exchanging information is disclosed. The system includes an encoder, wherein the encoder accesses a compression device. The system also includes a microlet transform generated by the compression device that embodies the information. The system also includes a decoder to decode the microlet transform into the information. Further according to the disclosed embodiments, a method for compressing information is disclosed. The method includes determining a data structure for the information. The method also includes affining a library with a microlet transform of the information, wherein the microlet transform accounts for the data structure. The method also includes sending the microlet transform.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1A illustrates a flowchart for encoding information for the basic transform according to the disclosed embodiments.

FIG. 1B illustrates a communication system according to the disclosed embodiments.

FIG. 2A illustrates a quadrature mirror filter for use in a communication system according to the disclosed embodiments.

FIG. 2B illustrates a shorthand notation of a quadrature mirror filter having a lossless two dimensional transformation according to the disclosed embodiments.

FIG. 3A illustrates a multi-resolution analysis diagram of a discrete wavelet transform according to the disclosed embodiments.

FIG. 3B illustrates an eight dimensional modem having a lossless eight dimensional transformation for use in a communication system according to the disclosed embodiments.

FIG. 4 illustrates a transversal filter system for use in a communication systems using microlet operations according to the disclosed embodiments.

### DETAILED DESCRIPTION OF THE PREFERRED EMBODIMENTS

Reference will now be made in detail to the preferred embodiment of the present invention, examples of which are illustrated in the accompanying drawings.

The embodiments of the present invention disclose a compression technology that utilizes the immeasurable depth and power of Quantum information. The disclosed compression is mapped to current industry standards, but adds a dimension to the ability to collect, categorize and “dig-down” into information that may not be possible in the classical two dimensional binary format.

The disclosed embodiments collect information based upon the 32 elemental structures of an electron. Everything that exists in one state or another is assembled via this base. There are billions of number states and sequences, and it gives the added qualities of classifying information on a true four dimensional level. This means that for terms like multiresolution analysis, there really are multi-levels, and sub-levels of information stored under one tiny source. The disclosed embodiments have far reaching applications aside from a compression model, as disclosed below. The disclosed embodiments seek to model information in the same way electrons store and build information. The modeling basis for the communications and computer environment may be used in a similar fashion for collecting “real” data for medical applications and mathematical studies.

The disclosed embodiments pertain to an electron model. An electron is a very tiny particle that is one of the building blocks of reality. The disclosed embodiments utilize electrons properties and the unbound ability to store information of any shape, form, or substance in a very finite system of measurements. The disclosed embodiment may use Quantum numbers. Quantum numbers is a term that was developed to help aid in describing electron behavior according to the Schrödinger Wave Equation. There are four basic quantum numbers, and they are usually designated as n, l, m, and s. Together, they will specify the energy level, type of orbital, orientation of the orbital the electron (s) may occupy, and the spin. The Principal quantum number (n) is the most important number. Its unique property allows for it to have any integer from one to infinity. This number should never be zero. The second number is the Azimuthal quantum number and its symbol is (1). This number may represent any non-negative integer from zero to infinity with always one less than (n). This is the number used to designate the types of orbitals. The third quantum number is the Magnetic quantum number and may be symbolized by (m). This number determines the direction of the orbital, as it is oriented in three dimensional space. The fourth of the primary four numbers is the Spin quantum number and is symbolized by (s). This number determines the spin of the electron and has a value of either ½ or −½. Other spin numbers may exist. There are four sublevels of (m) and they are classified in order of relation to the nucleus and are symbolized by (s) which has 1 orbital, (p) which has 3 orbitals, (d) which has 5 orbitals, and (f) which has 7 orbitals. Orbitals contain 1 or 2 electrons, and this gives 32 electrons if all 4 levels are fully occupied. One more very important rule may apply and that is the Pauli Exclusion Principle: No two electrons in an atom may have the same set of four quantum numbers. The quantum number is read from left to right beginning with the Principal number, so it reads (n,l,m,s). There are also a couple of symbols involved that describe the axis of an electron, and these are respectively (x), (y), (z), (Px, Py, Pz).

Based on the rules of the quantum electron, the embodiments disclose a language and very powerful compression model. This initial model may be a software based technology that later may be integrated into chip form. The disclosed embodiments incorporate complex mathematics involved in determining the feasibility of using a quantum electron to quantize information in a classical sense. The disclosed embodiments use the quantum model and its applicable rules as a base, and adding boundaries, rules that apply to the physical and architectural limitations of a classical computing environment.

By applying the “rules” and an algorithm that designates the four quantum numbers and their behaviors to a mapped model, the disclosed embodiments are able to generate a single affine transform that represents the embodied “information” stored in an electron in a pseudo-electron environment. A four dimensional lattice/array is utilized to collect information, and complete binary mappings are run through a synthetic quantum algorithm and the “bits” of binary or analog information are transposed into an electron-like setting. This setting is then transformed to produce an affine transform that represents all of this data in a single element. In terms of Huffman tree coding, a parent node is created and then individual branching children go either left or right. By going left, they may adapt a (1), and by going right they may adapt a (0). By doing this, the binary sequence was shortened.

The disclosed embodiments are able to map the detailed information by unique values into a single “node” in a manner similar but infinitely more sophisticated than known processes. There are a number of logics and mathematical models to use and the disclosed embodiments are incorporating various scenarios for different contexts, including the use of Euclidian matrices. Kleene linear algebra with affine closures/convex closure as defined in Hilbert/Banach space. Quantum logic as described in principal for the categorization of quantum mechanical evidences is also adjusted to fit the architecture for particular purposes. In conforming to traditional push down automata of the computer sciences field, it may be feasible to construct yet another working construct. Some of the classic themes like lattice matrices are adjusted to conform to a four dimensional environment and employed for cataloging a library. Like the ASCII method, the disclosed embodiments may represent the binary equivalent of some value via a smaller code that gets the same result.

The disclosed embodiments may be extremely scalable, just in the first two quantum possibilities one has an infinite number of combinations to create a single “symbol” representation of data. This process may be streamlined and works with any kind of data from very simple to extremely complex. The disclosed embodiments have the scalability to do Run Time Transforms like run time encoding. The disclosed embodiments can scale to desired bit lengths from 2, 4, 8, 12, 16, 24, 32 bit runs or any computationally beneficial length. For very large files, this feature may be important and inversely it may be important for smaller files that typically do not meet the threshold levels of typical compression models.

The transforms take minimal space so the disclosed embodiments can map a very diverse Library codebook. The disclosed embodiments are employing vector quantization-like fractal compression, and entropy encoding in a perfect environment and, because it is a symmetrical relationship, the decoding is the inverse operation of the encoding. However in fractal model or any “binary” based Iterated Function System, one quickly realizes that there are infinitely many different transformations. Initially this may be solved through a relationship between domain and range regions in the images. The transform codes patterns of self-similarity and relative position between self-similarity. These codes are mostly rotationally invariant because of the application of eight isometries in a domain pool. So, being a code of that does not have object invariance, or the essence of some position invariant pattern or texture that can be placed into the “codebook”, it does not allow for relational operators to allow for non-trivial categories that have more than one element.

The disclosed embodiments can map the same image in 100% detail in multiresolution with all of the relationships, and still have a single “symbol” to represent its properties. Waveform technologies have a lot of these similar properties as they are built on the foundation of the fundamental wavelike states of the electron. Utilizing the “brain” of these functions is the logical encompassing solution. One may normalize individual affine transforms into various types of category sets and policies, and the related correspondences from a category to an individual symbol into a very elegant Universal Decompression Library. This feature provides both an analog and a binary signature for every library symbol. This feature may use various tactics to normalize data, like computing conditional probabilities and establishing the hierarchical tracings forward into categories and backwards to the source.

For example, in the case of a high resolution picture going into the Library, the algorithm would encode the series of n-dimensional arrays (eg consider a hypothetical dataset v which has been encoded and is to be stored as a function of n=4 variables P, X, Y & Z at l, s, p, d values respectively; the array v thus contains a total of P×X×Y×Z elements). Almost without exception, the values of the n values (defining the formulas element grid-points of the hypothetical dataset) also should be stored for clarity and to allow interpolation. In order to make such datasets self-contained, to facilitate access and to remove the possibility of ambiguity, arrays containing the values of each of the parameters on which that dataset depend are therefore contained alongside the n-dimensional array containing the calibration dataset itself. For example, the disclosed embodiments may receive an image that is 1024×1024 using the quadtree of IFS fractal compression if broken into 10 areas with a pixel as the smallest resolution. If the ranges were to be no less than 16*16 and at a depth of two then resolution would be perfect. This is not the case with decomposition because it is arbitrarily chosen.

A simple q element base may be advanced into a four dimensional orientation by combining the entire spectrum of properties allowed. This information can be sorted and stored via an n-dimensional array ordered with the bin tables and parameters defined by the logic of the application.

A complex number class is needed to define a vector in Hilbert/Banach space because of the complexities. Each complex number is set to a complex value, and stored locally or virtually as a real and imaginary part, both of which are double precision floating point numbers. The length of a vector in Hilbert/Banach space with n components is defined to be: \sqrt{Σⱼⁿ=1|wj|²} where wj is the value of the j'th component of the vector, and |wj|² is defined to be wj times its complex conjugate, or when wj=a+i*b|wj|²=a²+b². To scale a vector by any length l one simply multiplies each component of the vector by the value of l. To scale a vector to length 1, one multiplies each component by the inverse length of the vector.

So in an electron configuration using the quantum principals as a memory compression, one can assume that the base value of a register is n bits and requires 2ⁿ complex numbers to represent its value. Given the quantum nature the register may exist as a superposition of any of these base states. To define a basic structure for description purposes of the power of this compression, the register consists of the 32 most basic electron states with a single complex number per base to describe the probability of the state being measured, thus giving 2²³ or 4.295×10⁹ base states. Assuming that the values are binary numbers and the most significant bit is the first or leftmost bit, then the numbers increase in a logical order, 0, 1, 2, 3, etc. In reality there are an infinite number of base states per bit, as the quantum nature of the electron has n=1−∞, and l=0−n−1−∞ with +½ and −½ spin value.

The disclosed embodiments may follow the convention that the probability of measuring the j'th state whose complex amplitude is wj is |wj|²/Σⱼ|wj|². Defining the Σⱼ|wj|² to correlate to the complex number in the algorithm can define the n place value equal to or greater than 1, allowing for the probability of measuring the j'th state is |wj|². In order to actuate this into a non-quantum computing environment some rules and member functions should be defined. A dump function may exist that will “dump” the entire state information of the members being analyzed without collapsing the register vector as would happen in a true quantum environment back to its base states.

A calculate probability state function may measure the amplitude probability of any given state. This will be used to calculate a microlet transform. In further defining and cataloging these amplitudes or states, it will not be necessary to measure this for each symbol in a real-time environment. After it has been cataloged and assigned an affine definition, only the changes in symbols will be measured and sent as these will be stored in the VQR, or Virtual Quantum Register. Because these n bits can be in any superposition of base states, the microlet may fulfill the transform function for the argument. The disclosed embodiments may define a simulation using 2ⁿ⁺¹ double precision floating point numbers to represent each state, and one Complex object to represent the probability amplitude of each of the 2ⁿ eigenstates of a n bit VQR, wherein each Complex object uses two double precision floating point numbers. It may seem that this uses more bits than a classic computer, but this is a side effect of the simulation. In the actual deployment this feature may use fewer bits to generate information, and will give an increased margin of compression, and ability for a single bit to carry at a minimum 64 times more information than known bits.

The disclosed embodiments allow one to maintain a full inventory of all the transactions in the VQR. This aspect becomes important for encryption and deciphering in parallelism, similar to quantum computing ability to crack codes. In a real quantum environment the modular exponentiation may perform one operation of X^{a} mod n, where a would be the superposition of the states in a quantum register.

A simulation corresponding to the disclosed embodiments may calculate for the superposition of values caused by calculating X^{a} mod n for a=0 through^{q-}1 iteratively. This action stores the results of each modular exponentiation, and uses that information to collapse the register to its base states. Performing this type of operation in a quantum environment would not be possible, because any measurement causes it to collapse back to its base states. The underlying mathematical model for completing the algorithm and finding a nontrivial factor of n can be defined by following Shor's algorithm in conjunction with the disclosed embodiments.

One of the possible advantages to this compression model aside is that it maintains some of the most advantageous attributes of digital like storage. The disclosed embodiments also have the properties of analog, so it can be easily transitioned from one environment to the next as it is coded both digitally and in analog in the VQR.

As part of building the initial library, an adaptive intelligent database system may be connected to the library to measure and compute the new transforms and measure everything from redundancies in programs to patterns in motion and cross correlation properties. For practical purposes, a sub-set of this library as disclosed above may be geared specifically at alpha/numeric, words, multi-media content, video on demand, and the like. The disclosed embodiments may normalize this data quickly and efficiently, and the library has an adaptive compression for chaotic and random data. An additional property, adaptive block coding and arithmetic coding based on quantum numbers also may be integrated. This feature will allow for data strings of varying background to be compared coded and stored.

The initial program in conjunction with the disclosed embodiments may code a tremendous amount of data into very small representations. In the disclosed process, incoming data that does not match any of the categories may be given a separate_analyze_compare_classify_detail_transform_send to string process. Update_model routines are collected after sampling from the database to be normalized and “hardcoded”. This action may capture the properties in a unique and very detailed fashion. The adaptive portion of the library is a least-used model; so that there is always information space as old processed information is overwritten or dropped.

For example, the disclosed embodiments may assign a value to n, l, m, s, to represent the letter (A) and its representation in quanta is (4, 1, 0, −½). This is characterized by an individual transform. Next, the disclosed embodiments want to send a (G) and its quanta representation is (4, 1, 0, +½). The only difference between these two characters in quanta is the spin, so instead of sending the entire string we just send the difference. By thinking of differences in the characters in terms of a large document or program, it may be apparent that large reductions in the amount of information or data being transferred may be achieved. The transfer of difference via a single symbol is very fast and very efficient.

The disclosed embodiments incorporate the use of microlets in the transmission, reception, manipulation, and the like of information. A microlet may be a non-binary code that can overlap in time without inter-symbol interference (“ISI”) and may increase robustness over known wavelets because a single sine curve carries a representation of compressed data. A microlet is a four dimensional maximized wavelet packet analyzer. Microlets are smaller and, therefore, potentially more resistant to noise than a wavelet. The overlap in time and sub-band space may provide a bandwidth efficiency of 6*B per second per hertz when the system sends B bits per symbol per sub-band. Additionally, the exponent and the magnitude of the compression format prior to receiving its signature may be multiplied. This feature may enable transmitted information to achieve an effective rate that exceeds the 2 B bps/Hz limit of a linear modem.

The disclosed embodiments may operate where modulation and demodulation over the network to network, or network to client, occur over commuting operators. The algorithm is mapped to the open systems interconnection (“OSI”) model. Compared to 30 Mbps 64 QAM pipes, the disclosed embodiments may provide up to a 9x reduction in port density and a up to a 27-x increase in channel data-carrying capacity at almost identical cost.

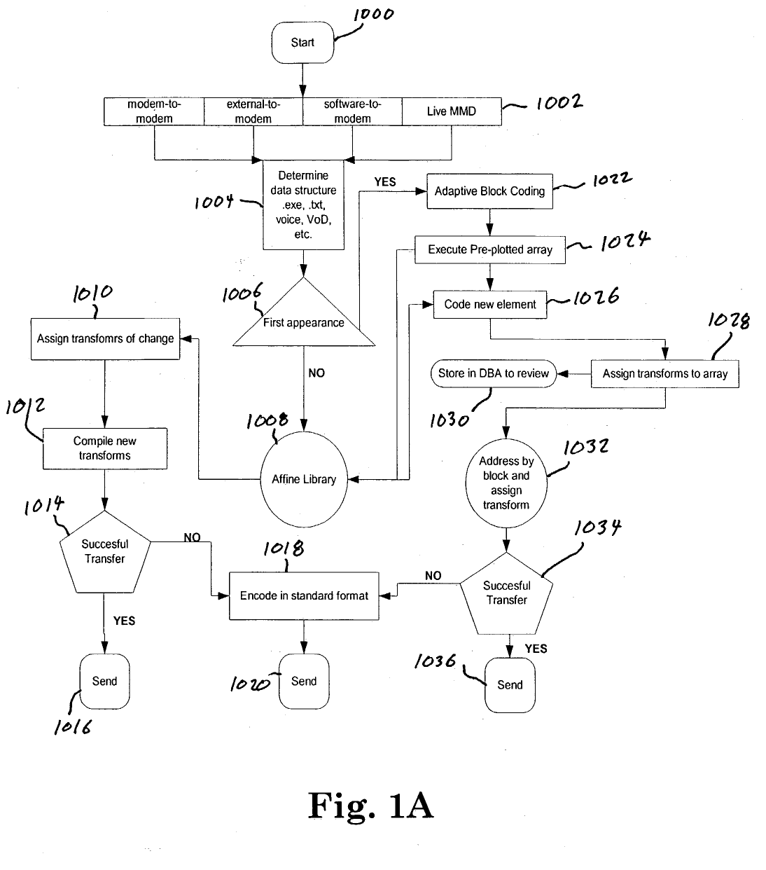

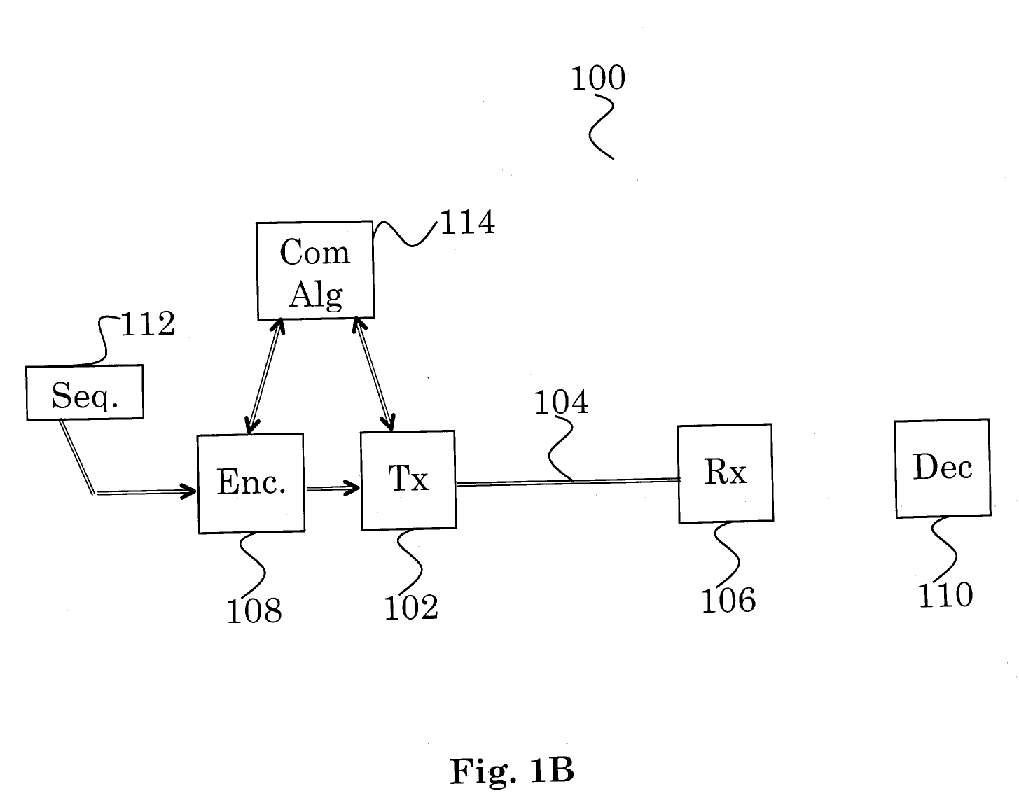

FIG. 1A depicts a flowchart for encoding information for the basic transform according to the disclosed embodiments. The process and methods disclosed with regard to FIG. 1A may be implemented by any hardware/software configuration. Further, the embodiments disclosed with reference to FIG. 1A may be applicable to all the embodiments disclosed below.

Step 1000 executes by starting the algorithm to encode information. Step 1000 may execute by any known means, such as receiving a command, at specified intervals, executing software commands, and the like. Step 1002 executes by receiving the information from a device, such as modem-to-modem, external device-to-modem, software-to-modem, live MMD, and the like.

Step 1004 executes by determining the data structure for transform. The data structure may be of any type known for use in exchanging information, such as exe, txt, voice, VoD, and the like. Step 1006 executes by determining whether this if the first appearance of the information. If no, then step 1008 executes by affining the library, as disclosed above. Step 1010 executes by assigning transforms of change to the information. Preferably, the quantum designations disclosed above may be assigned to the information received. Step 1012 executes by compiling the new transforms. Step 1014 executes by determining whether the transfer was successful. If yes, then step 1016 executes by sending the encoded information to a destination. If no, then step 1018 executes by encoding the information a standard format. Step 1020 executes by sending the information.

If step 1004 is yes, then step 1022 executes by performing adaptive block coding. Step 1024 executes by executing the pre-plotted array as disclosed above. Step 1024 may interact with step 1008 to affine the library. Step 1026 executes by coding the new element of the information. Step 1026 also may interact with step 1008 to affine the library. Step 1028 executes by assigning the transforms to the array. Step 1030 executes by storing in a database to review. Step 1032 executes by addressing by block and assigning transform. Step 1034 executes by determining whether the transfer was successful. If yes, then step 1038 executes by sending the information.

FIG. 1B depicts a communication system 100 according to the disclosed embodiments. Communication system 100 may exchange any type of information or data over all mediums. FIG. 1B may implement the embodiments disclosed with reference to FIG. 1A. For example, communication system 100 may exchange information over a network coupling various devices such as desktops, laptops, personal digital assistants, phones, and the like. Communication system 100 may exchange information in over a wireless medium, POTS, internet, local or wide area network and the like. Communication system 100 also may have OSI capabilities and features that allow various users to exchange data and information.

Within communication systems 100, transmitter 102 may send compressed, coefficient, tagged data sine curves as overlapping microlets in place of packets. These microlets may be sent over medium 104 to receiver 106. Microlets may overlap in time and frequency without interference due to cross-correlation properties of waveforms. Microlets, however, may provide improved characteristics over existing wavelet technology.

Encoder 108 and decoder 110 may facilitate the exchange process by encoding and decoding the data according to known methods. Encoding and decoding events may occur in addition to those processes correlating to microlets. Mapping the compression encoder 108 and decoder 110 at both ends allows for the sine waves to be either sent or decoded into information. By rotating the microlet 180 degrees, the microlet may be sent across the peak (middle) performance of a wavelet space, and may use powered sine curves and inverted sine curves to represent binary numbers such as 0 and 1.

Signal coordinates, or data coordinates, may represent information that is defined in a matrix space. For example, a contiguous set of z samples into a Digital/Analog converter are the signal coordinates of a z dimensional information matrix. The disclosed embodiments use the space between the base-band modulation operators {M} that provides the coordinate transformation to rotate data into a signal. Note that digital/analog converters are not depicted in FIG. 1, but known digital/analog converters may be incorporated into transmitter 102. Alternatively, known digital/analog converters may incorporated within any feature of communication system 100.

Wavelet mathematics may be applicable in the fields of imaging and compression. The disclosed embodiments may create a smaller and more robust waveform than known wavelets. Using base-band encoding and decoding, the disclosed embodiments use compression and tools like sequencer 112 to allocate information to various sub-bands and frequencies. The disclosed embodiments incorporate a unique roll-up compression scenario that compresses data of all types. The disclosed embodiments utilize a multi-step process that ends with assigning the data string to a small sine representation.

The disclosed embodiments allow tagged information to reach its correct destination. Tagged information may include packet voice data inside a microlet. The disclosed embodiments may utilize all media and is not limited to any specific medium. Thus, medium 104 may be any known or future medium capable of exchanging information and data within any form. For example, medium 104 may exchange digital or analog data. Moreover, microlets are supported by any medium capable of carrying signals. Further, the disclosed embodiments may address the troublesome last mile question, and applicability to synchronous optical network carriers. This feature may permit matching backend SONET speeds and provide speeds and capacities in excess of OC3 over existing hybrid fiber coaxial “HFC” infrastructure.

Compression device 114 may be any structure, algorithm, or program that facilitates compression of information and data within communication system 100. Compression device 114 may be stand alone or, alternatively, incorporated into encoder 108 or transmitter 102. Compression device 114 may be fed data to compress, or may access the data from another device, machine, and the like. Preferably, the disclosed embodiments implement a 2 Mpeg continuous looping method for compression and decompression. The disclosed embodiments may provide for real-time compression/decompression and microlet recognition. The disclosed embodiments may compress packetized data, raw data, voice, video, and the like in support of known compression standards.

Communication system 100 also may include a modem (not shown). Alternatively, communication system 100 may be implemented between two modems encompassing transmitter 102 and receiver 104. For example, transmitter 102 may be a known modem, and receiver 104 may be a modem, though not necessarily identical or equivalent to transmitter 102. Modulation and demodulation are mappings that may be denoted by the operators [M] and [D]. To recover the data or information exchanged over medium 104 correctly, [D] [M]=[I], or identity, for any modem group. Operators may work from right to left, and an overall delay may still be considered identity. If [M] [D]=[D] [M] over the bandwidth of the channel, then the operators may be said “to commute.” For a perfect commuting operator modem (“COM”), a band-limited Gaussian-like analog input signal, or bg, may be demodulated and remodulated at the transmitter 102 because [M] [D] bg=bg. This feature suggests that the modulation of a perfect COM may transmit via a band-limited analog input signal that may be a prerequisite for achieving communication, as disclosed below.

To transmit a Gaussian signal, no loss of entropy by [M] may be experienced. If [M] is a no-loss wavelet filter-bank, the entropy-power lost in filters of this type may be proportional to the width, or roll-off, of the pass-band to stopband transition of the two outermost sub-bands. This roll-off transition may be arbitrarily small for wavelet filters. Thus, a microlet, as disclosed, may be an optimal carrier for data across mediums incorporating modem architectures.

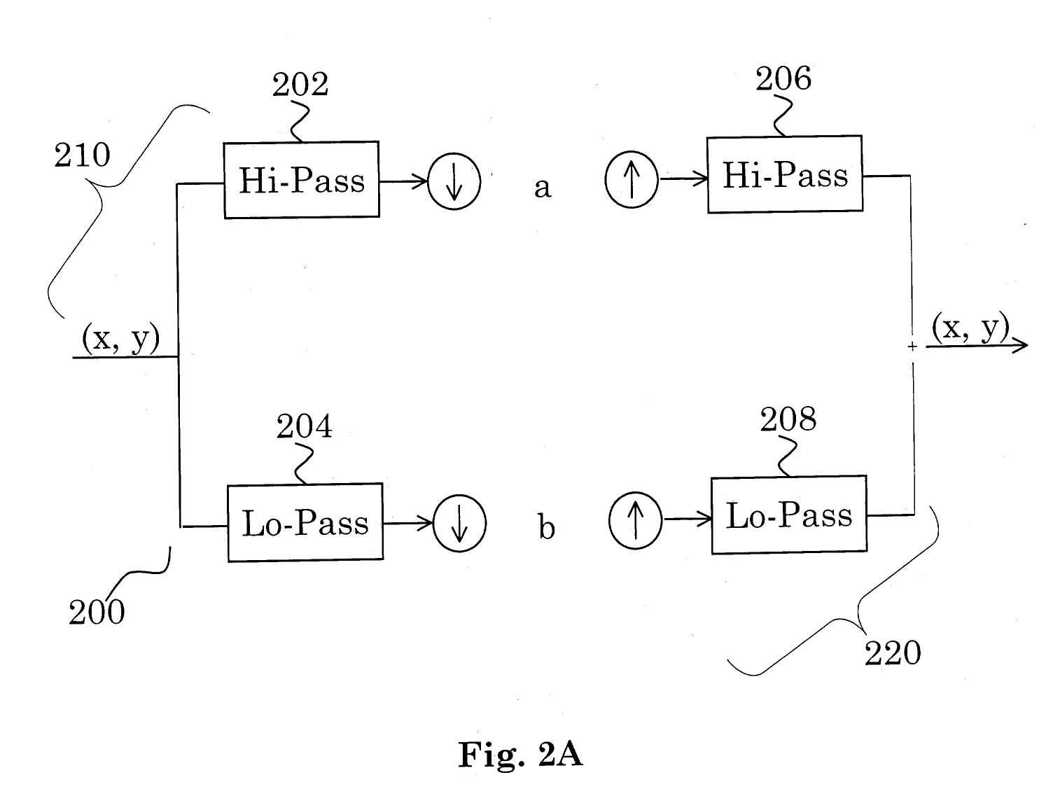

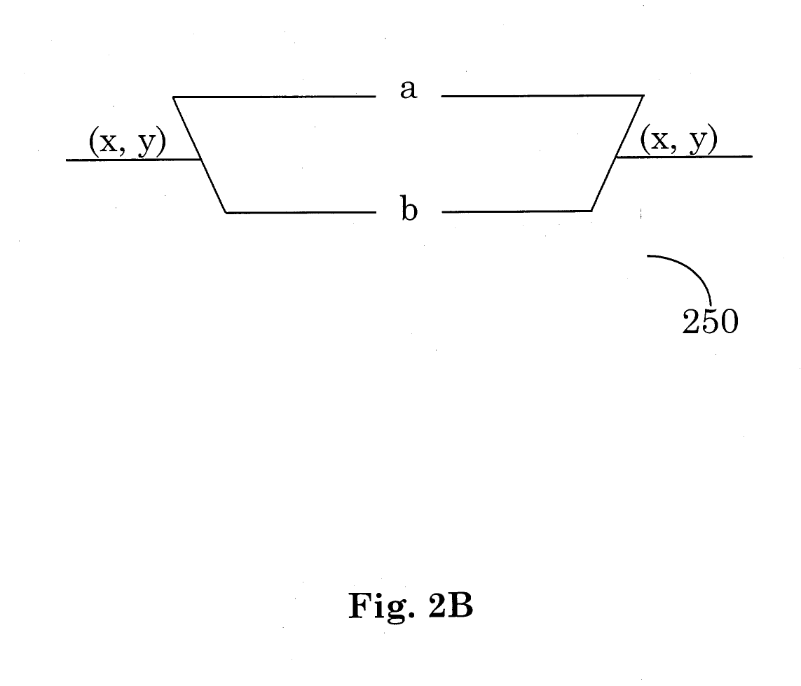

FIG. 2A depicts a quadrature mirror filter 200 for use in a communication system according to the disclosed embodiments. The embodiments of FIG. 2A may be used in a modem configuration according to the disclosed embodiments. Further, the embodiments disclosed with reference to FIG. 2A may facilitate the implementation of the embodiments disclosed in FIG. 1A. The commuting operators for microlets may be constructed as coefficient digital matrix operators, because any band-limited signal can be described by digital samples via a sampling theorem. Commuting matrix operators may be interpreted as geometric rotations of a vector in some coordinate system. Therefore, information may be a vector that is projected onto DATA or SIGNAL coordinate representations (i.e. axes) by a “rotation” of the axes. A preferred rotation may be 180 degrees, though the disclosed embodiments are not limited to such. Additionally, this information can be compressed into single character data strands and tagged prior to being interpreted as a sine wave.

Quadrature mirror filter (“QMF”) 200 takes vector (x,y) and rotates it to vector (a,b), and then rotates vector (a,b) back to vector (x,y). A set of M samples into the digital/analog of a baseband coefficient matrix modulator define an M-dimensional vector defined in time and bandwidth. The dual constraint on time and bandwidth may be possible in imaging, wavelets, and microlets. A synthesizer filter bank coupled to QMF 200 may transform the data representations of the information vector into a signal representation. Filter sub-bands may not be used actively for data if the sub-bands are above or below the channel bandwidth. According to encoder 108 of FIG. 1, the sample-rate, dimensionality, and roll-off for the filter bank are selected to match the active sub-bands to the channel bandwidth. The number of bits per symbol in each coordinate may be selected to suit the signal-to-noise ratio (“SNR”) in that sub-band.

The relationship for commuting rotation operators may satisfied by wavelet theory. QMF 200 may be the basic building block for wavelet transformations. As coded, individual microlets may be created and sent as pieces of a waveform. Coded microlets may be rotated 180 degrees, and then inverted 180 degrees instead of 90 degrees. Other coding schemes may be implemented according to the disclosed embodiments. The encoding layer may utilize a 26 -character map for data and a 10 digit code for numeric with the entire spectrum of color. Signatures may be assigned to compression, encoding, tagged, and sequenced, that allows for separation at the head end and allows for coexistence in the space or bit.

Incoming signals are divided by analyzer 210 into high pass branch filter 202 and low pass branch filter 204, and then may be down-sampled. Preferably, the signals are down-sampled by 2. This process also may discard every other sample. Two input samples (x,y) are transformed into two band-limited samples (a,b), one in each branch filter 202 and 204. This transformation may be called a rotation. The sequences of (x,y) and (a,b) may be both defined in vector spaces of the same dimensions because of the down sampling.

As disclosed above, QMF 200 may be a subset of a general case. The sub-bands may not be limited to being equal, as quadrature may be defined as a sample rate that is equal of the bandwidth, so long as the information in the input function X(n−1), that is not in the scaling function V(N), is in the residual function W(N), such that W(N)=X(n−1)−V(N).

Synthesizer 220 up-samples each incoming branch by inserting a zero sample. Then, high pass branch filter 206 and low pass branch filter 208 are filtered and summed to form the reconstructed signal samples. By implementing the filters to obey the equations of a geometric rotation in two dimensions, the reconstructed samples match the incoming signal with, at most, an overall delay. Synthesizer 220 may rotate a sequence of two dimensional vectors from one representation to another, and analyzer 210 performs the exact counter-rotation.

When the filters have finite impulse response (“FIR”), the filter coefficients may be samples of orthogonal functions. A number of FIR designs may be possible for QMF 200. QMF 200 may be implemented without utilizing geometric rotations. The commuting rotation operator technique may provide an exact match despite the possibility of a roundoff error.

A pair of commuting matrix operators for two dimensional vectors may include the geometrical coordinate rotation operator [R], and its inverse [C], the counter-rotation through an angle A, or,

[R]=cos(A)−sin(A);

[C]=cos(A)sin(A);

sin(A)cos(A)−sin(A)cos(A).

For a rotation angle of A=45 degrees, [R] may be proportional to a wavelet matrix, or [W]=1−11.

The above example shows that a microlet can code the data in a band-limited way using the same orthogonal function as the “spreading chip-code” for Direct-Sequence Spread-Spectrum Code Division Multiplexing (“DS-SS CDMA”). By combining the spread spectrum with microlets, one obtains a “Twice-Coded” and greater compressed modulation. The following discussion informs as to the disclosed embodiments and the microlet technology. The disclosed embodiments provide a realizable method for transmission either with the accompaniment of existing platforms, or using the disclosed embodiments as a stand-alone component.

Recalling the earlier operator definitions, the choice of [M]=[R] and [D]=[C] for a commuting operator modem (“COM”), is equivalent to modulation with a one-section, 4-port lattice filter. Cascading filters with different rotation angles may improve the filter response, if so desired. The following disclosed construction for a commuting operator modem is an adaptation to modems of the filter design methods.

Because a commuting rotation in three dimensions may be decomposed into an ordered sequence of rotations in two dimensions and so forth, the disclosed embodiments may apply to modems with vectors of any dimensionality. Thus, higher dimensions can be derived from the two dimensional case. Furthermore, there may be more than one set of commuting operators for a given dimension. This feature results in the concept of “Master and Slave sets” of wavelets that are orthogonal within each set and somewhat orthogonal between sets to provide a property that can be exploited for full-duplex communications.

FIG. 2B depicts a shorthand notation of a quadrature mirror filter 250 having a lossless two dimensional transformation according to the disclosed embodiments. QMF 250 may be implemented in a plurality of ways to modem operators. The resultant rotation matrices [M] and [D] may be known as polyphase filter matrices. Before defining polyphase matrices and their relation to filter response, additional disclosure of QMFs may be given.

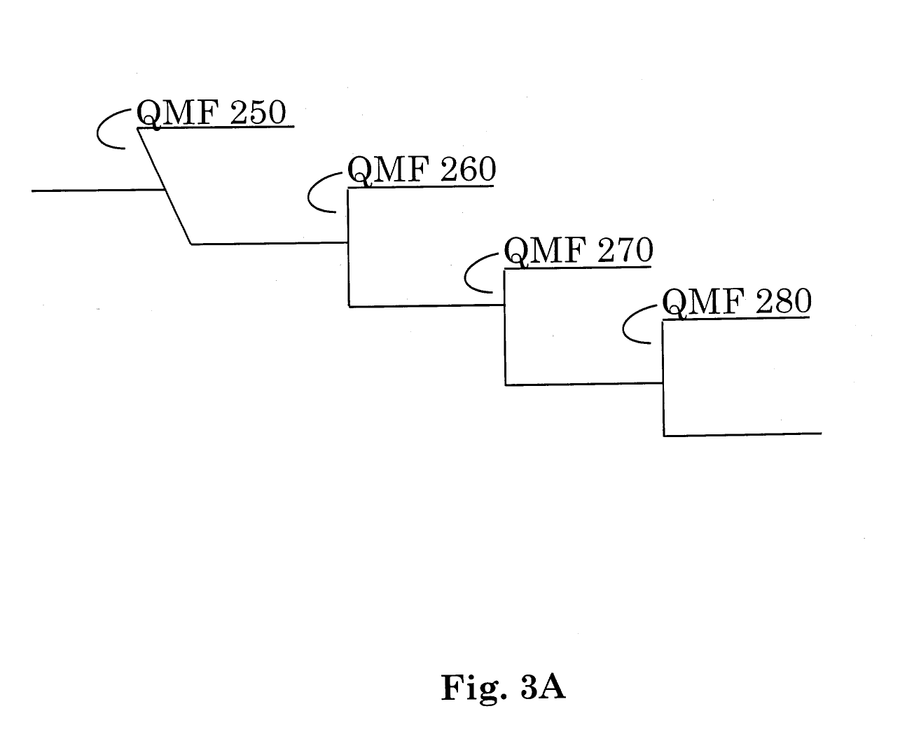

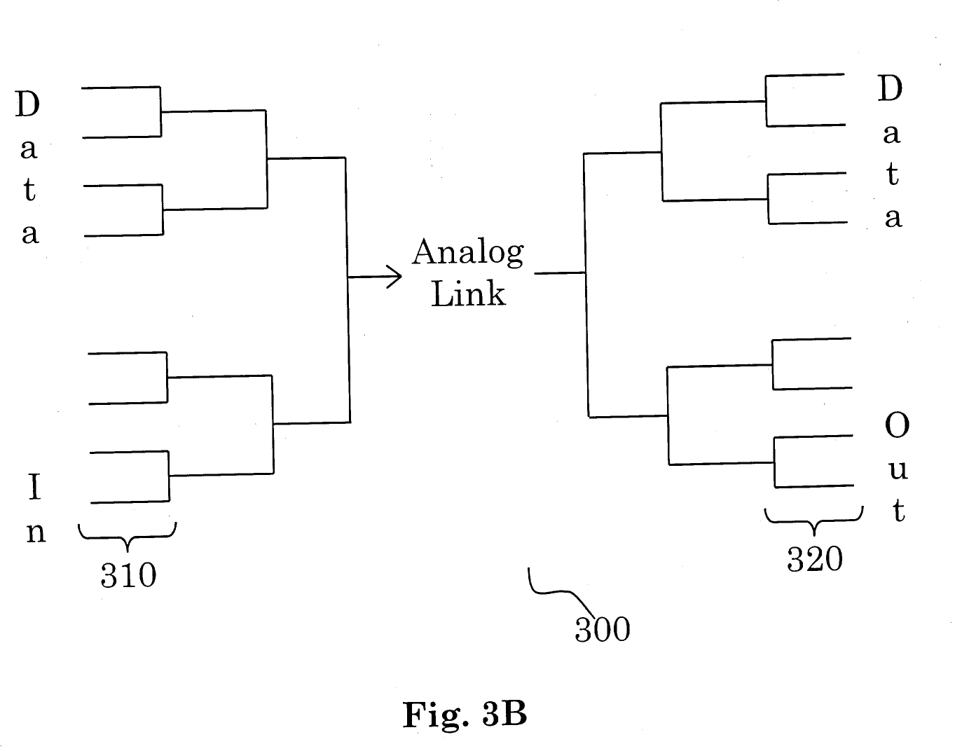

FIG. 3A depicts a multi-resolution analysis diagram of a discrete wavelet transform according to the disclosed embodiments. In a multi-resolution analysis (“MRA”), another QMF pair 260 may be placed in the low pass branch of QMF 250, and then a third QMF 270 may be placed in the low pass branch of the second QMF 260. Another QMF 280 may be placed in the low pass branch of QMF 270. The result may be a canonical form of the discrete wavelet transform (“DWT”). The original signal may projected onto orthogonal basis functions by the QMFs. Because of the down sampling, the sample rate is halved in each stage.

A modem based on FIG. 3A may be optimal for twisted pair and other media where there is a steep change in SNR at low frequencies and a gradual change at higher frequencies. Various modems implementing the disclosed embodiments may have unequal width sub-bands, including non-octave.

Referring back to FIG. 2A, analyzer 210 decomposes the signal as an expansion in orthogonal basis functions, but unlike the Fourier decomposition, the generating functions have finite support. That is, wavelets may not extend to infinity like sinusoids.

There is one generator of Fourier functions; namely, the complex exponential, which extends to infinity. Many examples, however, of wavelet generators exist, such as the Spline function. In both expansions, the generator function's argument is shifted by k and scaled in frequency to create the basis functions. Wavelets usually scale the frequency by powers of two to represent down sampling. In this example, the expansion coefficients are called the discrete wavelet transform and are the projection of X onto the basis.

FIG. 3B depicts an eight dimensional modem 300 having a lossless eight dimensional transformation for use in a communication system according to the disclosed embodiments. Modem 300 facilitates the transform of information as disclosed with reference to FIG. 1A. If an MRA is performed in the high-pass branches as well as the low pass branches, then the result is M sub-bands at the same down-sampled rate. Rather than use two dimensional QMFs, the M-band bank of FIG. 3B, for any value of M, may be more efficiently constructed from commuting M-dimensional rotations using ordered sets of two dimensional rotations. The M-band filter banks 310 and 320 perform a convolutional rotation in m dimensions directly. Filter banks 310 may act as an analyzer, and filter banks 320 may act as a synthesizer, as disclosed above. The equivalent QMF has M bandpass filters with a sample rate change by a factor of M.

A vector coordinate rotation is used to implement a modem. The rotation can be viewed as “vector-filtering” by factoring the polyphase matrix of a QMF filter bank. This terminology and its relation to hardware implementations for modems is disclosed below to utilize multi-rate filter-banks. Polyphase matrices are known in sub-band coded speech compression, although the vector-filter concept of the disclosed embodiments express the matrices that gives added insight for modem applications in a novel manner.

A polyphase matrix is a computational simplification of the filtering process due to the change in the sampling rates in a QMF bank, such QMF banks 310 and 320 of modem 300. Referring back to synthesizer 220 of FIG. 2A, each FIR filter performs a weighted sum of its delayed input stream. Due to up sampling, every other sample into the delay filter line is zero. Only half the tap weights, such as the even numbered filter coefficients, contribute to the even numbered output samples. The odd numbered weights contribute to the odd output samples. When computing output samples, half-length filters may be used if each computes at half the rate of the output. This feature extends to a factor of 1/M for an m-dimensional (m-band) filter bank, and is responsible for the low computational complexity of QMFs and microlets.

These observations are applied to the modem receiver by factoring the filter coefficients of the 2-Dimensional receiver's filters into even and odd powers of z. Thus, the response of the receiver's high-pass analyzer filter 206 may be:

$$\begin{matrix}H1 ( z ) = az0 + bz \text{-} 1 + cz \text{-} 2 + dz \text{-} 3 + … \\ = ( az0 + cz \text{-} 2 + … ) + z \text{-} 1 ( bz \text{-} 1 + dz \text{-} 3 + … ) \\ = h00 ( z2 ) + z \text{-} 1 h01 ( z2 )\end{matrix}$$

Because there are two analyzer filters, high pass filter 202, and low pass filter 204, the pair of filters may be disclosed by a vector H. Thus:

H(z)=[h(z)]d(z), where

H=H0(z) d=1 and [H]=h00(Z2) h01(Z2)

H1(z)z−1 h10(Z2) h11(Z2)

And d is called a delay vector. The more general case of an m dimensional filter bank may be shown as:

H=[h(zzM)]d where the transpose of d is z0+z−1+z−2+z−3+ . . . z−(M−1).

FIG. 2A also depicts a change in sample-rate. To complete the description of the preferred modem, the up sampling and down sampling operators are denoted by [up] and [dn]. Then, the modem receiver is [dn]H and the transmitter is G[up]. A simplification known as the “noble identities” in multi-rate filter theory may be applied, such that [dn][h (zM)]=[h(z)][dn]. Thus, [dn] H=[h (z)][dn] d=[h (z)][sp], where [dn] d makes a serial-to-parallel converter, with [sp] positioned after the demodulator's A/D. Similar mathematics may apply to the transmitter yielding a parallel-to-serial conversion prior to the D/A converter. In other words, the modem operates at the down sampled rate on non-overlapping frames of digital samples, which are the SIGNAL or DATA vectors disclosed above.

The matrix [h (z)] is called the polyphase filter matrix. The polyphase filler matrix may be a square matrix with each of its M×M matrix elements as a filter, hjk(z). These sub-rate filters can be represented as the scalar product of a coefficient vector, vjk, with a delay vector, z. That is, hjk=vjk*z, where z can have any storage length as needed for sharp band roll off.

Two polyphase matrices may exist, one for the transmitter and one for the receiver. The transmit and receive polyphase filter matrices for the preferred modem may commute with a delay, that is [h(z)] [g(z)]=[g(z)] [h(z)]=z [I]. In filter theory, this result is described as a perfect reconstruction filter-bank and may be designed for any number of ports using the commuting lattice filter method described earlier. A near-perfect reconstruction is used for filter banks, wherein the perfect design subsequently is computer optimized to improve the stopband attenuation or other filter design tradeoffs.

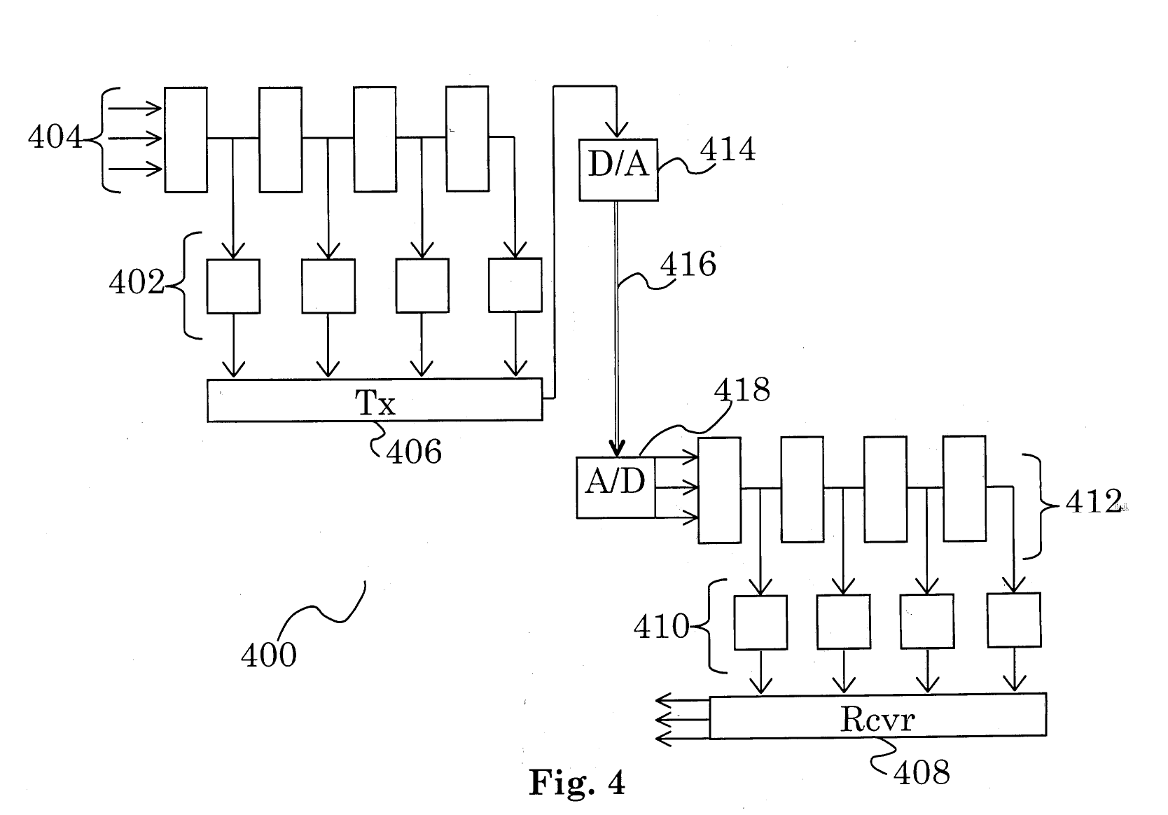

FIG. 4 depicts a transversal filter system 400 for use in a communication systems using microlet operations according to the disclosed embodiments. By assembling all the polyphase terms with like powers in z, a polyphase filter matrix may be factored into the form of a vector-filter, or [h]=[c0]z0+[c1]z−1+[c2]z−2+[c3]z−3+ . . . [cN−1]z−(N−1). Transversal filter system 400 may be known except that the tap weights are M×M scalar coefficient matrices 402 and the delay-line contains vectors such as the current, or z0, and N−1 prior vector inputs 404. For transmitter 406, the input vectors are the data vectors, and for receiver 408, the input vectors are the signal vectors, such as contiguous frames of A/D samples. The number of tap matrices 410, n, may be 1, but, preferably, is around 5 for a modem. Tap matrices 410 may depend on the desired filter response. The transmitter 406 and receiver 408 vector filters are matched, so that the coefficient matrices are time-reversed to allow the configuration of one vector-filter to determine the other. The rows and columns of the coefficient matrices are segments of wavelet functions. The more taps, the longer the tails of the wavelet and the sharper the roll-off of each sub-band. Reduced energy is in the tails.

The vector-filter concept discloses the duality of the matrix and wavelet approaches to the preferred modem operation. This feature provides that the disclosed compression and microlet technology may operate at increased speeds and have about equal or better quality than existing transmissions. In transmitter 406, for example, the M components of the output vectors become M samples into D/A converter 414. The transmitted signal samples are computed from the current and past data vectors by vector addition after mapping with matrices. Thus, vector-filters perform “rotations” and counter-rotations that preserve information during the modem transmission over pipe 416. Pipe 416 may be any medium that exchanges information. The vector-filter also demonstrates that equivalence of rotations versus the synthesizer/analyzer disclosure above.

The vector-filter modem also may be understood in terms of orthogonal functions, where every wavelet is orthogonal to any other wavelet that is shifted by any multiple of M samples. By superposition, a sequence of data vectors may be analyzed by examining a single symbol impulse on one data axis. As a single component of a data vector “impulse” proceeds through the vector-filter's shift register on subsequent null symbols. There are M samples per segment and the number of segments may equal the number of tap-matrices, n. Because the overlapping wavelets for each symbol are orthogonal when the superposition principle is applied, there is no ISI or ACI for a complete modem system.

The matrices for receiver 408 contain the time-reversed wavelets so that the vector-filter of receiver 408 computes the correlation between each orthogonal wavelet and the received signal to recover the data vectors. This may be known as an optimal maximum apriori probability receiver.

Thus, wavelet-based technologies may be preferred for receiver 408, and may have the following features. First, receiver 408 may be self-equalizing by applying any adaptive equalization algorithm, such as LMS, to the vector-filter matrices in the same manner as FSE. Further, interference may be suppressed because the symbols are recovered by correlation. Moreover, FIR vector filtering on transmitter 406 or receiver 408 may be performed in the analog domain with SAWs or CCDs, such that no D/A or A/D converter or digital signal processor has high rates. In addition, fractional bits per vector coordinate may be assigned according to SNR.

Because vector-filtering is a convolution modulation, a receiver Viterbi Algorithm may provide error-correction without sending parity at transmitter 406. This feature may be desirable because conventional modulation sends parity, and wastes transmitted entropy and lowers the potential data rate. Vector-filters may be used for compression-less networking, but with a compression format that generates sine waves instead of packetized data representation. The disclosed microlet and compression support packetized data representations.

In order to satisfy some of the Video on Demand (VoD) and media criteria, exceptional quality and lossless transfer are desirable. DVD quality and known video standards require optimal professional quality and high-bandwidth. A couple features may be desirable to compress media for companies to allow for narrow-band users to access their information: Entities may need to be able to compress their media to a very small and lossless file, (an hour of digitized video may require 70.4 gigabytes of storage space) an accessible way to distribute the media contents to different destinations, (for DVD/ITU quality throughput demand can reach as high as 20 MB/s/Data-rate calculation: 720×486 pixels×30 fps×2 components/pixel×1 byte/component=20.02 MB/sec.) and the ability to catalog and store the media in more than one location.

With the disclosed compression technology, the embodiments may capture that 70.4 GB and compress it by a minimum factor of about 32 times. With our modem technology we can expect to see throughputs in the neighborhood of around 20 MB/sec over copper realistically, and exceed 200 MB/sec on broadband pipes. Coupled with the compression engine we can offer a very complete solution including the on-site compression and storage of the content. The storage would be cut down proportionate to the compression or possibly more for static situations. Obviously the storage market is a very reasonable expectation.

The adaptive nature of the disclosed embodiments is another possible advantage of the present invention. This feature lends itself well to a couple of known problems, concerns, and outright desires of some industries; theft, and encryption. The nature of the disclosed compression allows for an infinite number of possible numbers and/or character representations. Producing a software component KeyGen (Key Generator), the disclosed embodiments can assure maximum encryption. The entire base code or parameters can be reassigned by the KeyGen and the only way to decipher it is with the mate codec. It is entirely feasible to cross this with an existing connection and actually have two channels of communication going on with two separate codes. This feature may solve, or at least from a virtual sense, the entertainment industry's struggle to prevent theft of their movies, media, and songs. This feature may be one way to prevent unwanted downloads, copying, and presents a very unique way to integrate VoD to customer premise.

The disclosed embodiments include the hardware design of a chipset based on the disclosed compression and qualities from the modem technology like the lifting scheme that lend themselves to create a very impressive design. This chipset will allow for far greater capacities in compression and direct computation time on the computer. The disclosed embodiments may allow for a vastly more scalable computer base with a computer language that allows for modeling and computation.

It will be apparent to those skilled in the art that various modifications and variations may be implemented for the disclosed embodiments without departing from the spirit or scope of the invention. Thus, it is intended that the present invention covers the modifications and variations of this invention provided that they come within the scope of any claims and their equivalents.

What is claimed:

1. A system for exchanging information using microlets, comprising:
an encoder, wherein said encoder accesses a compression device;
a microlet transform generated by said compression device that embodies said information; and
a decoder to decode said microlet transform into said information.

2. The system of claim 1, wherein said encoder comprises said compression device.

3. A method for compressing information, comprising:
determining a data structure for said information;
affining a library with a microlet transform of said information, wherein said microlet transform accounts for said data structure; and
sending said microlet transform.
